(19) United States
(12) Patent Application Publication
(10) Pub. No.: US 2026/0330288 A1
(43) Pub. Date: Oct. 22, 2026

(54) FEDERATED LEARNING SYSTEM AND FEDERATED LEARNING METHOD

(71) Applicant: HITACHI, LTD., Tokyo (JP)

(72) Inventor: Takahito Tanimura, Tokyo (JP)

(73) Assignee: HITACHI, LTD., Tokyo (JP)

(21) Appl. No.: 19/110,531

(22) PCT Filed: Oct. 12, 2023
(86) PCT No.: PCT/JP2023/037045

§ 371 Date: Mar. 11, 2025

(30) Foreign Application Priority Data
Nov. 10, 2022 (JP) 2022-180015

(51) Int. Cl. G06N 20/00

(52) U.S. Cl. CPC G06N 20/00

(57) ABSTRACT

A data augmentation process of augmenting data and a learning model generation process of generating a predetermined learning model from the data augmented by the data augmentation process is executed. Data property characteristic information is calculated that indicates a characteristic property of the data from e augmented data is executed. When the data property characteristic information of one client terminal does not satisfy a predetermined relationship with the data property characteristic information of another client terminal, the predetermined data augmentation method is adjusted, and the intensity of the augmentation by the data augmentation method is executed for the one client terminal, using the predetermined learning model generated from the augmented data, such that the data property characteristic information items of the two client terminals satisfy the predetermined relationship.

### TECHNICAL FIELD

The present invention relates to a federated learning system and a federated learning method.

### BACKGROUND ART

Currently, many technologies including big data, blockchain, and artificial intelligence (AI) are being applied to business in a wide range of of industries. At the same time, with the passage of the General Data Protection Regulation (GDPR) in Europe and the privacy protection bill currently under consideration in the United States against the backdrop of geopolitical decoupling, it is becoming more difficult to collect data from around the world and to use the data unrestrictedly. Under these circumstances, the use of federated learning (FL) is increasing.

The federated learning is a modeling method that ensures data security and has great potential for application in various fields. The reason is that the use of the federated learning makes it possible to train an AI model that can be commonly used among a large number of businesses while protecting privacy and data sovereignty. However, the problem with the federated learning in which a large number of businesses cooperate to train an AI model while concealing confidential information from one another is that, when there is a large difference in data collection environment between locations, heterogeneity in the statistical properties of local learning data held by each location is high, which results in degradation of the performance and versatility of the common AI model obtained by the federated learning.

Techniques for solving this problem are disclosed in, for example, Non-Patent Document 1 and Non-Patent Document 2. Non-Patent Document 1 proposes a method called FedProx and discloses a technique that integrates models between locations with different statistical properties using a proximal operator. In addition, Non-Patent Document 2 discloses a technique that is called Agnostic FL and integrates models between locations with different statistical properties using a method of minimizing a worst-case loss function between clients.

### CITATION LIST

### Non-Patent Document

Non-Patent Document 1: Tian Li, Amit Kumar Sahu, Manzil Zaheer, Maziar Sanjabi, Ameet Talwalkar, and Virginia Smith. Federated optimization in heterogeneous networks. Proceedings of Machine Learning and Systems, 2:429-450, 2020.
Non-Patent Document 2: Mehryar Mohri, Gary Sivek, and Ananda Theertha Suresh. Agnostic federated learning. In International Conference on Machine Learning, pages 4615-4625. PMLR, 2019.

### SUMMARY OF THE INVENTION

### Problems to be Solved by the Invention

Non-Patent Documents 1 and 2 disclose improved algorithm approaches for integrating local models trained by a plurality of clients having data with different statistical properties in the federated learning. The use of these techniques makes it possible to build a common AI model between a large number of business offices/operators with different data collection environments while suppressing performance degradation and avoiding an increase in system integration (SI) costs caused by individual AI optimization (learning). However, when there is a large difference between the data collection environments at each location, it is still difficult to suppress the performance degradation of the common model in the techniques according to the related art. For example, when a difference in the angle of view, resolution, focus, illuminance, and the like in the acquisition of a video at each location is larger than a predetermined value, the performance degradation of the common AI model is likely to occur due to the difference that is not capable of being fully suppressed in Non-Patent Documents 1 and 2. Further, Non-Patent Documents 1 and 2 focus on an aggregation algorithm of the local model, but do not disclose the modification of the properties of the data held by each location, which is expected to further improve the overall performance through repeated improvements to the algorithm.

An object of the present invention is to provide a technique that can suppress performance degradation of a common AI model more effectively than the related art.

### Solutions to Problems

According to the present invention, there is provided a federated learning system including a plurality of client terminals and a server performing federated learning on data to be processed by each of the plurality of client terminals. Each of the plurality of client terminals executes a data augmentation process of augmenting the data to be processed based on a predetermined data augmentation method an intensity of augmentation by the data augmentation method, executes a learning model generation process of generating a predetermined learning model from the data augmented by the data augmentation process according to a predetermined parameter, and executes a calculation process of calculating data property characteristic information indicating a characteristic property of the data from the augmented data. When the data property characteristic information of one of the client terminals does not satisfy a predetermined relationship with the data property characteristic information of another client terminal, the server executes an adjustment process of adjusting the predetermined data augmentation method and the intensity of the augmentation by the data augmentation method for the one client terminal, using the predetermined learning model generated from the augmented data, such that the data property characteristic information items of the two client terminals satisfy the predetermined relationship, and the one client terminal executes the data augmentation process, the learning model generation process, and the calculation process based on the adjusted predetermined data augmentation method and the adjusted intensity of the augmentation by the data augmentation method.

### Effects of the Invention

According to the present invention, it is possible to suppress the performance degradation of the common AI model more effectively than the related art. Objects, configurations, and effects other than those described above will become apparent from the following description of the embodiments of the invention.

### BRIEF DESCRIPTION OF THE DRAWINGS

FIG. 1 is a diagram showing an example of a configuration of a federated learning system according to this embodiment.

FIG. 2 is a diagram showing another example of the configuration of the federated learning system according to this embodiment.

FIG. 3 is a diagram showing an example of a schematic configuration of a computer.

FIG. 4 is a diagram showing a functional configuration of this system.

FIG. 5 is a diagram showing a flow of data processed by an FL client.

FIG. 6 is a diagram showing a procedure of generating an AI model from local data D.

FIG. 7 is a flowchart showing a processing procedure of a process (data augmentation federated learning process) performed in this embodiment.

FIG. 8 is a flowchart showing a detailed processing procedure of a data augmentation process (S702) shown in FIG. 7.

FIG. 9 is a diagram showing an example of a configuration of a federated learning system according to this embodiment (Embodiment 2).

FIG. 10 is a diagram showing a procedure of generating an AI model from local data.

FIG. 11 is a flowchart showing a processing procedure of a data augmentation federated learning process performed in this embodiment.

FIG. 12 is a diagram showing an example of a configuration of a federated learning system according to this embodiment (Embodiment 3).

FIG. 13 is a diagram showing a procedure of generating an AI model from local data.

FIG. 14 is a flowchart showing a processing procedure of a data augmentation federated learning process performed in this embodiment.

FIG. 15 is a diagram showing an example of an interface screen displayed on a display device 305 by a hyperparameter designation unit of an FL client in each embodiment.

### MODE FOR CARRYING OUT THE INVENTION

Hereinafter, an embodiment of the present invention will be described with reference to the drawings. The following description and drawings are examples for explaining the present invention, and some omissions and simplifications are made as appropriate for clarity of explanation. The present invention can be embodied in various other forms. Unless otherwise specified, each component may be singular or plural.

The position, size, shape, range, and the like of each component shown in the drawings may not indicate the actual position, size, shape, range, and the like of each component in order to facilitate understanding of the invention. Therefore, the present invention is not necessarily limited to the position, size, shape, range, and the like of each component disclosed in the drawings.

In the following description, various types of information are described using expressions such as a “database”, a “table”, and a “list”. However, the various types of information may be expressed using data structures other than these. An “XX table”, an “XX list”, and the like may be referred to as “XX information” in order to indicate that they are not dependent on the data structure. In the description of identification information, when expressions, such as “identification information”, an “identifier”, a “name”, an “ID”, and a “number”, are used, they are interchangeable.

When there are a plurality of components having the same or similar functions, different subscripts may be attached to the same reference numerals in the description of the plurality of components. However, when it is not necessary to distinguish between the plurality of components, the subscripts may be omitted in the description of the plurality of components.

In addition, in the following description, a process performed by executing a program may be described. However, the program is executed by a processor (for example, a CPU or a graphics processing unit (GPU)) to perform a given process while appropriately using, for example, a storage resource (for example, a memory) and/or an interface device (for example, a communication port). Therefore, the subject of the process may be the processor. Similarly, the subject of the process performed by executing the program may be a controller, a device, a system, a computer, or a node having the processor. The subject of the process performed by executing the program may be a calculation unit and may include a dedicated circuit (for example, a field-programmable gate array (FPGA) or an application specific integrated circuit (ASIC)) that performs a specific process.

The program may be installed in a device, such as a computer, from a program source. For example, the program source may be a program distribution server or a computer-readable storage medium. When the program source is the program distribution server, the program distribution server may include a processor and a storage resource that stores the program to be distributed, and the processor of the program distribution server may distribute, to other computers, the program to be distributed. Furthermore, in the following description, two or more programs may be implemented as one program, or one program may be implemented as two or more programs.

### Embodiment 1

Hereinafter, an embodiment of a federated learning system and a federated learning method according to this embodiment will be described.

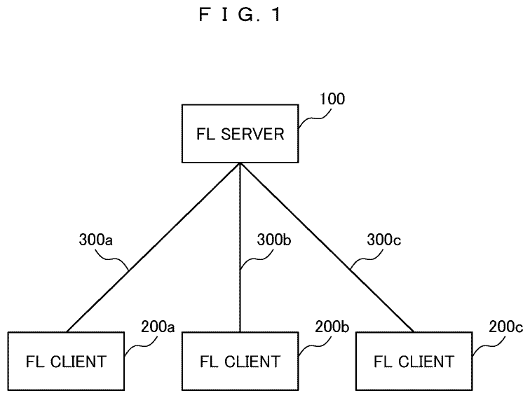

FIG. 1 is a diagram showing an example of a configuration of the federated learning system according to this embodiment. As shown in FIG. 1, a federated learning system 1000 is configured to include a federated learning server (hereinafter, referred to as an FL server) 100 that constructs a common AI model using each extracted AI model extracted from a data-augmented local AI model generated in one or more federated learning clients (hereinafter, referred to as FL clients) 200 and performs federated learning, an FL client 200 that is installed at a location, such as a business office, generates the extracted AI model from the data-augmented local AI model, and transmits the extracted AI model to the FL server 100, and a network 300 that connects the FL server 100 and the FL client 200. The network 300 is a general communication line and may be either a wired network or a wireless network.

In the following description, a case where each of the FL server 100 and the FL client 200 is configured by a single computer is given as an example. However, all or some of the functions thereof may be dispersively provided in one or more computers, and the computers may communicate with each other via the network to implement the same functions. In addition, FIG. 1 shows a case where, in the federated learning system 1000, the FL clients 200 (200a, 200b, and 200c) installed at three locations are connected by networks 300 (300a, 300b, and 300c), respectively. However, the number of FL clients is determined arbitrarily depending on the environment in which this system is applied. Data augmentation, a local AI model, a common AI model, and the like will be described in detail below.

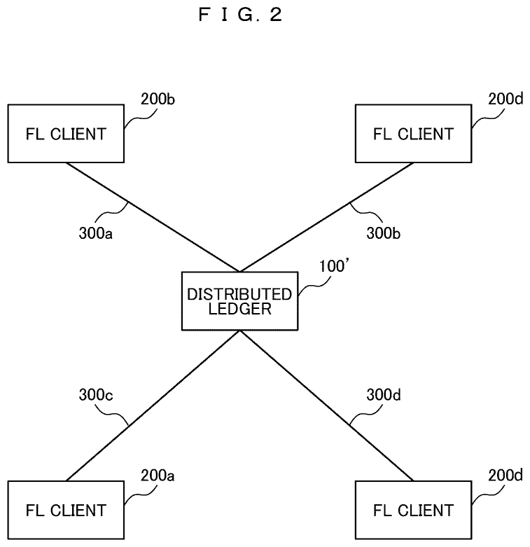

FIG. 1 shows an example of an aggregation-type configuration of this system using the FL server 100. However, this system may also be configured as a decentralized type. In a federated learning system 1000′ shown in FIG. 2, a distributed ledger 100′ that is typified by a blockchain and a plurality of FL clients 200 (200a, 200b, 200c, and 200d) are connected via networks 300 (300a, 300b, 300c, and 300d), respectively. Each FL client 200 transmits the trained data-augmented local AI model to the distributed ledger 100′, and the distributed ledger 100′ constructs a common AI model using an extracted AI model extracted based on the data-augmented local AI model received from each FL client 200 and performs federated learning. This makes it possible to reduce the risk of tampering with each FL client 200 and the risk of a system failure.

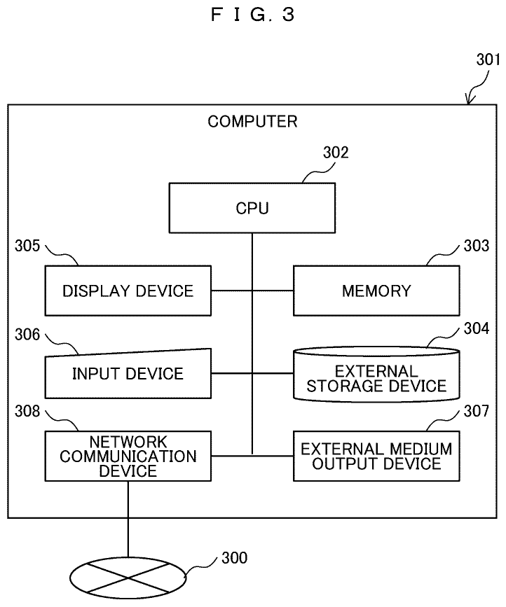

The FL server 100 and the FL clients 200 constituting the federated learning system 1000 can be implemented, for example, by a general computer 301 including a CPU 302, a memory 303, an external storage device 304, such as a hard disk drive (HDD), an external medium output device 307 that reads and writes information from and to a portable storage medium, such as a compact disk (CD) or a USB memory, an input device 306, such as a keyboard or a mouse, an output device 305, such as a display, and a network communication device 308, such as a network interface card (NIC), for connection to a communication network, as shown in FIG. 3 (schematic computer diagram).

Further, the CPU 302 can read out various types of data that are stored in this system or used in processes from the memory 303 or the external storage device 304 and use the various types of data to implement the various types of data. In addition, the CPU 302 can load a predetermined program stored in the external storage device 304 onto the memory 303 and execute the program to implement each functional unit (for example, a data augmentation execution unit 201, an augmentation instruction unit 202, a data property characteristic information calculation unit 203, an AI model generation unit 204, an AI model extraction unit 205, and a hyperparameter designation unit 206 which will be described below) of the federated learning system 1000.

The predetermined program may be stored (downloaded) in the external storage device 304 from a storage medium via the external media output device 307 or from the network via the network communication device 308, may be loaded onto the memory 303, and may be executed by the CPU 302. In addition, the predetermined program may be directly loaded onto the memory 303 from the storage medium via the external media output device 307 or from the network via the network communication device 308 and may be executed by the CPU 302.

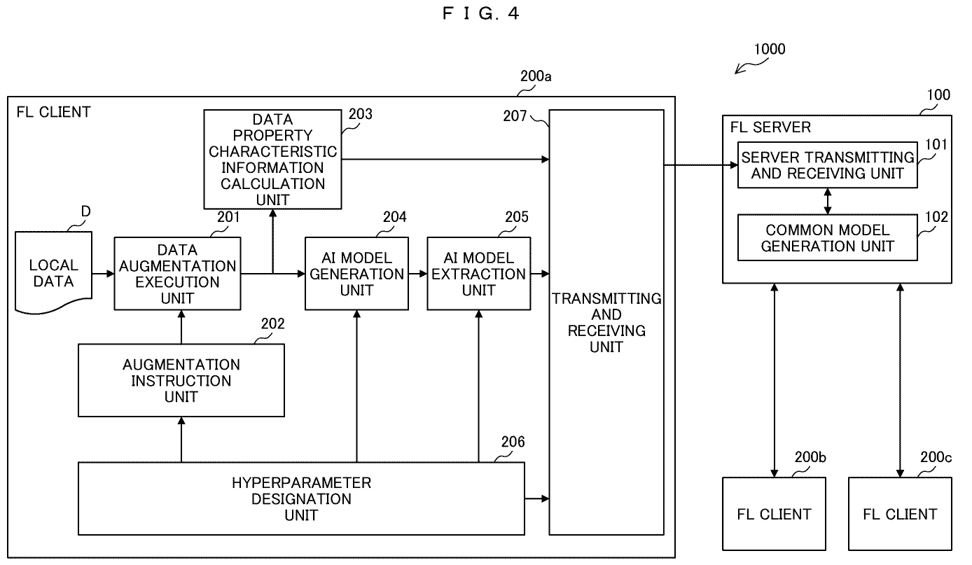

FIG. 4 is a diagram showing a functional configuration of this system. In FIG. 4, the FL client 200a will be described as a representative of the FL clients 200, and the same applies to the FL client 200b and the FL client 200c.

As shown in FIG. 4, the FL server 100 is configured to include: a server transmitting and receiving unit 101 that outputs an extracted AI model obtained by extracting information necessary for federated learning from a predetermined AI model, which has been generated by the AI model generation unit 204 and received from each FL client 200, to a common model generation unit 102 and transmits, to the FL client 200, an adjusted augmentation method and intensity for local data D which is the basis of the extracted AI model used for the common AI model output by the common model generation unit 102; and the common model generation unit 102 that executes a federated learning process using the extracted AI model of each FL client 100 received from the server transmitting and receiving unit 101 and outputs the adjusted augmentation method and intensity to the Server transmitting and receiving unit 101. A specific process performed by the FL server 100 will be described below using a flowchart.

The FL client 200 is configured to include: the data augmentation execution unit 201 that performs a data augmentation process of augmenting the local data D stored in the external storage device 304 with the augmentation method and intensity designated by the augmentation instruction unit 202; the augmentation instruction unit 202 that extracts the augmentation method and intensity to be used in the data augmentation process from parameters designated by the hyperparameter designation unit 206 and outputs the extracted augmentation method and intensity to the data augmentation execution unit 201; the data property characteristic information calculation unit 203 that calculates data property characteristic information of the augmented local data output by the data augmentation process of the data augmentation execution unit 201; the AI model generation unit 204 that reads parameters other than the augmentation method and intensity designated by the hyperparameter designation unit 206 and generates a predetermined AI model from the augmented local data output by the data augmentation process; the AI model extraction unit 205 that outputs the extracted AI model m obtained by extracting information necessary for federated learning from the predetermined AI model; the hyperparameter designation unit 206 that receives, from the user, the input of hyperparameters for controlling a behavior when an AI model is generated and outputs the hyperparameters to the augmentation instruction unit 202, the AI model generation unit 204, the AI model extraction unit 205, and a transmitting and receiving unit 207; and the transmitting and receiving unit 207 that transmits the extracted AI model output by the AI model extraction unit 205 and the data property characteristic information to the FL server 100 and receives the adjusted augmentation method and intensity from the FL server 100. In addition, the local data D may not be stored in the external storage device 304, and the data to be processed by the FL client 200 may be read from a device or an apparatus other than this system.

Hereinafter, further description will be made using the drawings. This system is characterized in that each FL client used for the federated learning can perform data augmentation on the local data to be processed, with different augmentation methods and intensities. This makes it possible to reduce heterogeneity in statistical properties of data between the FL clients. Then, it is possible to perform data augmentation using an augmentation method suitable for the environment of each FL client and to generate a more well-distributed and similar data distribution. Further, the data augmentation is a technique that is widely used in machine learning in order to increase the diversity of learning data. Examples of the data augmentation for image data include rotation, translation, cropping, scaling, shearing, inversion, brightness change, channel shift, background subtraction, image threshold processing, image smoothing, image gradient and edge detection, scale conversion, basis conversion, and noise addition and noise removal. In the data augmentation, in general, the number of data items and the diversity of data are increased, which makes it possible to improve the performance of the model. Next, the data processed by the FL client 200 will be described.

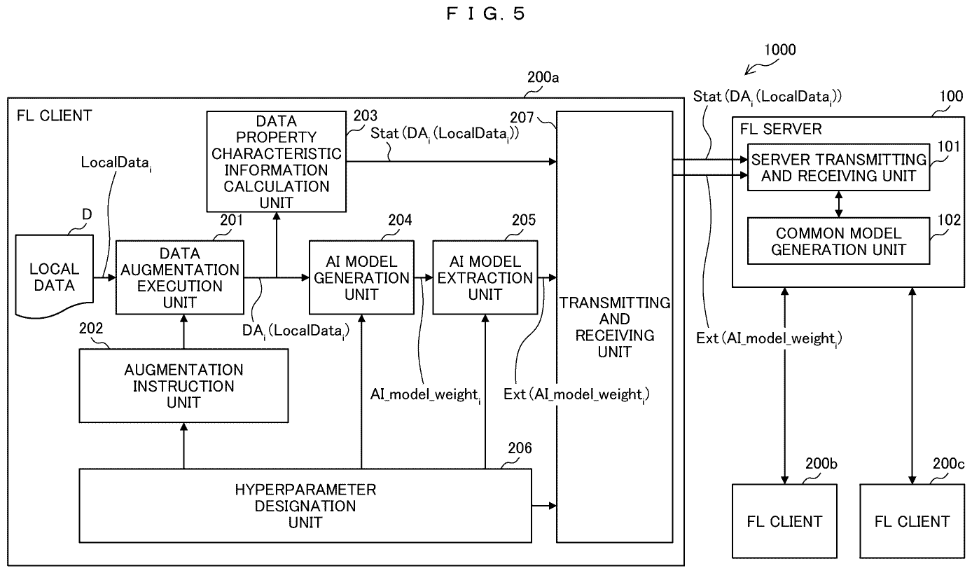

FIG. 5 is a diagram showing a flow of the data processed by the FL client 200. As shown in FIG. 5, the data augmentation execution unit 201 reads “LocalData_i” as the local data D. The subscript i is the number of local data items D and is any number that is determined according to the type of local data handled by each FL client 200. The same applies to the subscript of each data item that will be described below.

Further, the data augmentation execution unit 201 performs a data augmentation process in response to an instruction from the augmentation instruction unit 202 and outputs data DA_i (LocalData_i) after the data augmentation process. For example, when the local data D is image data, the augmentation instruction unit 202 designates items of the data augmentation process, such as rotation, translation, cropping, scaling, shearing, inversion, brightness change, channel shift, background subtraction, image threshold processing, image smoothing, image gradient and edge detection, scale conversion, basis conversion, and noise addition and noise removal, for the image data and outputs parameters indicating the degrees of augmentation of the items to the data augmentation execution unit 201. The data augmentation execution unit 201 performs the data augmentation according to the parameters. These parameters are designated by the hyperparameter designation unit 206.

The data property characteristic information calculation unit 203 reads the data DA_i (LocalData_i) after the data augmentation process, calculates data property characteristic information of the data, and outputs the calculated data property characteristic information Stat (DA_i (LocalData_i)). The data property characteristic information is information indicating a characteristic property of the data. For example, when the local data D is image data, the data property characteristic information calculation unit 203 calculates a characteristic property of the image data as the data property characteristic information of the data based on statistical values such as the average value and variance of the entire image or each channel. Alternatively, the data property characteristic information calculation unit 203 may use a data distribution calculated from a data feature amount converted by a trained encoder as the data property characteristic information of the data. Alternatively, the data property characteristic information calculation unit 203 may use an estimated ratio or statistic of a background and a foreground in the entire image as the data property characteristic information of the data. Then, the transmitting and receiving unit 207 transmits the data property characteristic information of the data to the FL server 100.

Furthermore, in the FL client 200, the AI model generation unit 204 receives the data DA_i (LocalData_i) after the data augmentation process output by the data augmentation execution unit 201 and the parameters other than the augmentation method and intensity designated by the hyperparameter designation unit 206 and generates a data-augmented local AI model in the FL client 200.

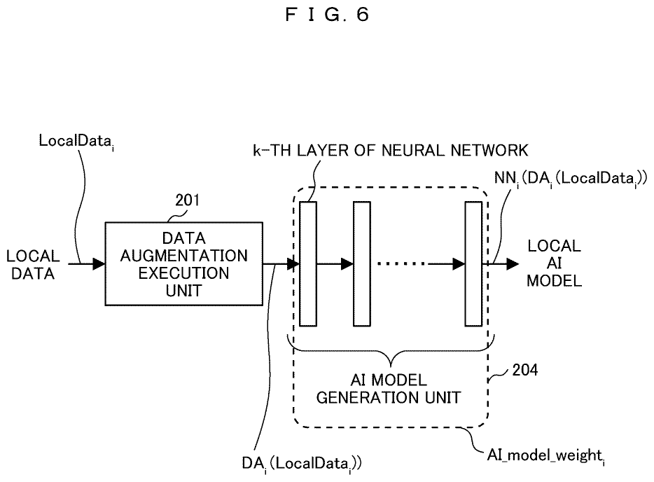

FIG. 6 is a diagram showing a procedure of generating the AI model from the local data D. As shown in FIG. 6, first, the data augmentation execution unit 201 reads the local data D, performs the above-described data augmentation process, and outputs the data DA_i (LocalData_i) after the data augmentation process. The AI model generation unit 204 inputs the data DA_i (LocalData_i) to a k-layer neural network to generate a local AI model NN_i (DA_i (LocalData_i)).

Returning to FIG. 5, the AI model extraction unit 205 outputs, to the transmitting and receiving unit 207, an extracted AI model Ext (AI_model_weight_i) obtained by extracting information necessary for federated learning from the AI model generated by the AI model generation unit 204. The transmitting and receiving unit 207 transmits the extracted AI model Ext (AI_model_weight_i) to the FL server 100. As described above, the FL client 200 transmits the data property characteristic information of the data and the extracted AI model Ext (AI_model_weight_i) to the FL server 100. The FL server 100 performs federated learning using the data for each FL client 200, which has been received from the FL client 200, to generate a common AI model and transmits, to each FL client 200, the generated common AI model and the adjusted augmentation method and intensity for the local data D which is the basis of the extracted AI model used for the common AI model.

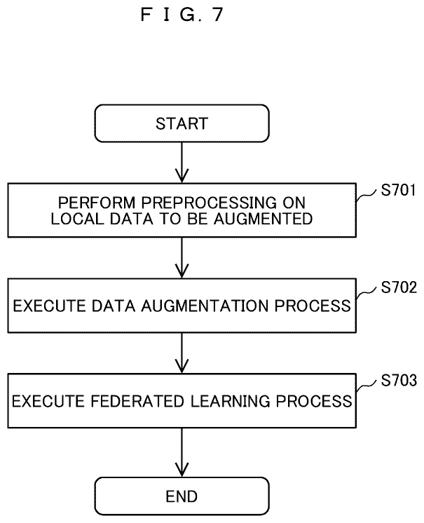

Next, the process performed in Embodiment 1 will be described. FIG. 7 is a flowchart showing a procedure of the process (data augmentation federated learning process) performed in this embodiment.

As shown in FIG. 7, in the data augmentation federated learning process, first, in each FL client 200, the AI model generation unit 204 performs preprocessing on the local data to be subjected to data augmentation (S701). The preprocessing is, for example, a process of initializing neurons of the neural network.

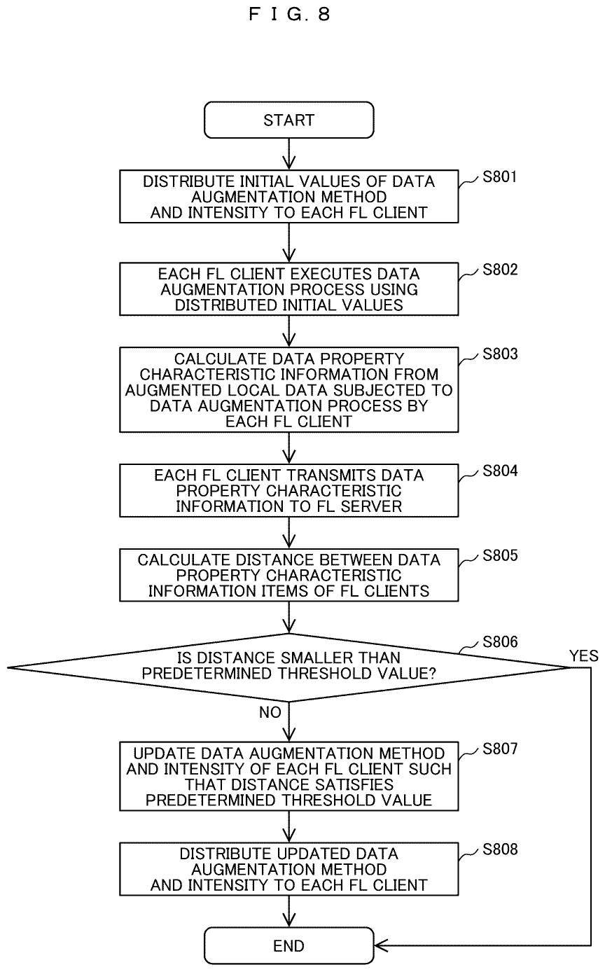

Then, each FL client 200 and the FL server 100 perform the data augmentation process on the local data with the designated data augmentation method and intensity to adjust the augmentation method and intensity for the local data D of each FL client 200 which is the basis of the extracted AI model used for the common AI model (S702). A specific process in S702 will be described below using FIG. 8.

When the process in S702 is ended, the common model generation unit 102 of the FL server 100 performs a federated learning process, using the extracted AI model extracted from the local AI model whose data has been augmented with the adjusted augmentation method and intensity, to generate a new common AI model and transmits the generated common AI model and the adjusted augmentation method and intensity to each FL client 200 (S703). The process may be repeated until the performance of the new common AI model is equal to or higher than a predetermined level.

When the process of S703 is ended, the data augmentation process is performed on the local data of each FL client 200 with the adjusted augmentation method and intensity. Therefore, for example, a common AI model that suppresses a difference in data collection environments for each location that manages the FL client 200 can be generated and reflected in each FL client 200.

FIG. 8 is a flowchart showing a detailed processing procedure of the data augmentation process (S702) shown in FIG. 7. As shown in FIG. 8, in the data augmentation process, first, the common model generation unit 102 of the FL server 100 distributes initial values of the data augmentation method and intensity (S801). For example, the initial values are stored in advance in the memory 303 or the external storage device 304 of the FL server 100.

Then, in each FL client 200, the data augmentation execution unit 201 executes the data augmentation process using the initial values received from the FL server 100 (S802). For example, when the local data D is image data, the data augmentation execution unit 201 reads the items of the data augmentation process, such as rotation, translation, clipping, scaling, shearing, inversion, brightness change, channel shift, background subtraction, image threshold processing, image smoothing, image gradient and edge detection, scale conversion, basis conversion, and noise addition and noise removal, and parameters indicating the extent to which the value of each of the items is to be augmented from the initial values received from the FL server 100 and executes the data augmentation process on the local data D for each item.

In each FL client 200, the data property characteristic information calculation unit 203 calculates data property characteristic information from the augmented local data subjected to the data augmentation process (S803). As described above, for example, a data distribution calculated from statistical values, such as the average value and variance of the entire image or each channel, and the data feature amount converted by the trained encoder is calculated as the data property characteristic information.

The transmitting and receiving unit 207 of each FL client 200 transmits the data property characteristic information calculated by the data property characteristic information calculation unit 203 to the FL server 100 (S804).

When the server transmitting and receiving unit 101 of the FL server 100 receives the data property characteristic information from each FL client 200, the common model generation unit 102 calculates a distance between the data property characteristic information items received from each FL client 200 (S805). For example, the common model generation unit 102 calculates the distance between the data property characteristic information received from the FL client 200a and the data property characteristic information received from the FL client 200b or 200c. Here, the FL client 200a will be described, but the distance between the data property characteristic information items is calculated similarly for the other FL clients 200. Here, the common model generation unit 102 can use, for example, the Kullback-Leibler pseudo distance or the Maximum Mean Discrepancy (MMD) as the distance between the data property characteristic information items.

The common model generation unit 102 determines whether or not the distance between the data property characteristic information items is smaller than a predetermined threshold value (S806). For example, the common model generation unit 102 determines whether or not the distance between the data property characteristic information received from the FL client 200a and the data property characteristic information received from the FL client 200b or 200c is smaller than a predetermined threshold value α. In this case, the determination is performed on all of the FL clients 200 as in S805.

The common model generation unit 102 performs the determination on all of the FL clients 200. When determining that there is an FL client 200 for which the distance between the data property characteristic information items is smaller than the predetermined threshold value (S806; Yes), the common model generation unit 102 ends this process on the FL client 200. On the other hand, when determining that there is an FL client 200 for which the distance between the data property characteristic information items is not smaller than the predetermined threshold value (S806; No), the common model generation unit 102 proceeds to a process in S807 for the FL client 200.

For the FL client 200 for which it is determined that the distance between the data property characteristic information items is not smaller than the predetermined threshold value, the common model generation unit 102 updates the data augmentation method and intensity of each FL client 200 such that the distance between the data property characteristic information items is reduced (S807). For example, similarly to a case where a general optimization problem is solved, the common model generation unit 102 calculates combinations of the data augmentation methods and intensities of the FL clients 200 satisfying the predetermined threshold value, selects a combination of the data augmentation method and intensity for achieving the smallest distance between the data property characteristic information items among the calculated combinations, and updates the previous data augmentation method and intensity to the selected data augmentation method and intensity.

The server transmitting and receiving unit 101 of the FL server 100 distributes, to the FL client 200, the data augmentation method and intensity of the FL client 200 satisfying the threshold value updated and adjusted by the common model generation unit 102 (S808).

As described above, the federated learning system 1000 according to Embodiment 1 includes a plurality of client terminals (FL clients 200) and a server (FL server 100) that performs federated learning on data (local data D) to be processed by each of the plurality of client terminals. Each of the plurality of client terminals executes a data augmentation process (the process by the data augmentation execution unit 201) of augmenting the data to be processed based on a predetermined data augmentation method (rotation, translation, clipping, scaling, shearing, inversion, brightness change, channel shift, background subtraction, image threshold processing, image smoothing, image gradient and edge detection, scale conversion, basis conversion, noise addition and noise removal, and the like) and the intensity of the augmentation by the data augmentation method, executes a learning model generation process (the AI model generation process 204 and the process by the AI model extraction unit 205) of generating a predetermined learning model (the local AI model or the extracted AI model) from the data augmented by the data augmentation process according to predetermined parameters (the parameters designated by the hyperparameter designation unit 206 and the augmentation instruction unit 202), and executes a calculation process (the process by the data property characteristic information calculation unit 203) of calculating data property characteristic information indicating a characteristic property of the data from the augmented data. When the data property characteristic information of one (for example, the FL client 200a) of the client terminals does not satisfy a predetermined relationship with the data property characteristic information of another client terminal (for example, the FL client 200b or 200c) (when the data property characteristic information does not satisfy a condition that the distance between the data property characteristic information items is smaller than the predetermined threshold value), the server executes an adjustment process of adjusting the predetermined data augmentation method and the intensity of the augmentation by the data augmentation method for the one client terminal, using the predetermined learning model generated from the augmented data, such that the data property characteristic information items of the two client terminals satisfy the predetermined relationship. The one client terminal executes the data augmentation process, the learning model generation process, and the calculation process based on the adjusted predetermined data augmentation method and the adjusted intensity of the augmentation by the data augmentation method. Therefore, it is possible to suppress the performance degradation of the common AI model as compared to the related art.

### Embodiment 2

In Embodiment 1, the data augmentation process is directly performed on the local data read by each FL client 200. However, when the data augmentation process is directly performed on the local data, the optimal data augmentation method and intensity may not be necessarily distributed to each location due to overlearning. Therefore, in this embodiment, the local data is not extracted, but feature amounts obtained by freezing weights of a certain layer constituting the neural network to fix some features are extracted. Then, data augmentation is performed on a latent representation vector after the extraction. A processing unit for extracting the feature amount can be designed manually and may be a unit obtained by freezing weighting parameters of the neural network that has been pre-trained with an open data set. When a better latent representation can be obtained by the processing unit for extracting the feature amount, the data augmentation can be simplified and generalized. For example, the data augmentation can be performed by adding noise sampled from a designated distribution to the latent representation vector.

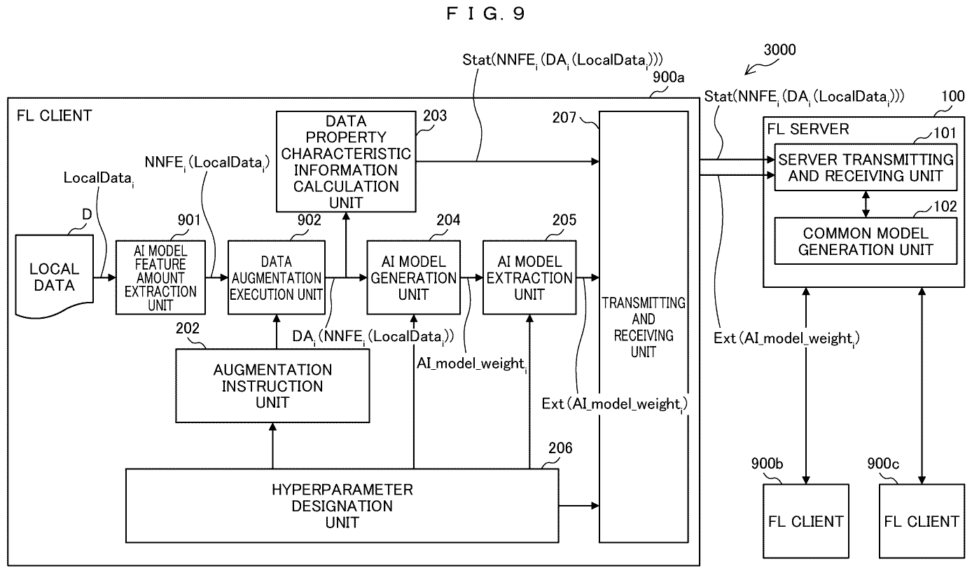

FIG. 9 is a diagram showing an example of a configuration of a federated learning system according to this embodiment. As shown in FIG. 9, a federated learning system 2000 includes an FL client that has the same configuration as the FL client 200 according to Embodiment 1 except that it further includes an AI model feature amount extraction unit 901 which is a processing unit for extracting the feature amount. In addition, the FL client includes a data augmentation execution unit 902 different from the data augmentation execution unit 201 according to Embodiment 1. In the following description, the same components as those according to Embodiment 1 are denoted by the same reference numerals, and a description thereof will be omitted.

The AI model feature amount extraction unit 901 reads local data and outputs an image feature amount vector. For example, when the local data D is image data, the image feature amount vector is generated by performing a feature amount extraction process of extract feature amount of the image data obtained by freezing weights of a predetermined layer constituting the neural network to fix the weights and by outputting the extracted feature amount as data in a latent representation vector format. The data augmentation execution unit 201 adds noise sampled from the designated distribution to the output data in the latent representation vector format to execute the data augmentation process. Then, the AI model generation unit 204 generates a predetermined AI model from the augmented local data output by the data augmentation process as in Embodiment 1.

In FIG. 9, the AI model feature amount extraction unit 901 reads “LocalData_i” as the local data D and outputs data NNFE_i (LocalData_i) in the above-described latent representation vector format. The subscript i may be considered as in Embodiment 1.

In addition, the data augmentation execution unit 902 performs the above-described data augmentation process in response to an instruction from the augmentation instruction unit 202 and outputs data DA_i (NNFE_i (LocalData_i)) after the data augmentation process. For example, when the local data D is image data, the augmentation instruction unit 202 outputs the same parameters as those in Embodiment 1 to the data augmentation execution unit 902.

The data property characteristic information calculation unit 203 reads the data DA_i (NNFE_i (LocalData_i)) after the data augmentation process, calculates data property characteristic information of the data, and outputs the calculated data property characteristic information Stat (NNFE_i (DA_i (LocalData_i))). The data property characteristic information calculation unit 203 calculates, as the data property characteristic information of the data, the characteristic property of the image data, which is the local data D, based on statistical values, such as the average value and variance of the entire image or each channel of the image data, as in Embodiment 1. Alternatively, the data property characteristic information calculation unit 203 may use a data distribution calculated from the data feature amount converted by the trained encoder as the data property characteristic information of the data. Then, the transmitting and receiving unit 207 transmits the data property characteristic information of the data to the FL server 100, and the AI model generation unit 204 generates a data-augmented local AI model in the FL client 200 as in Embodiment 1.

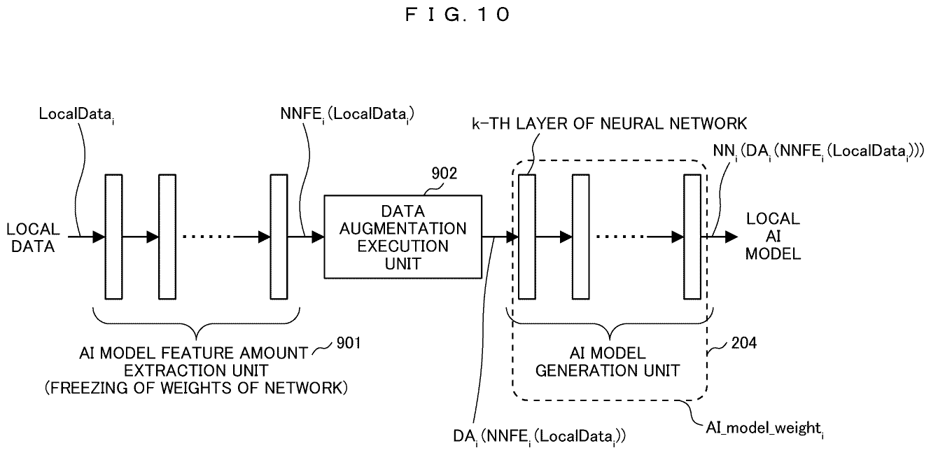

FIG. 10 is a diagram showing a procedure of generating an AI model from the local data D. As shown in FIG. 10, first, the AI model feature amount extraction unit 901 reads the local data D, performs the feature amount extraction process, and outputs the data NNFE_i (LocalData_i) in the latent representation vector format. Then, the data augmentation execution unit 902 performs the data augmentation process on the data in the latent expression vector format and outputs the data DA_i (NNFE_i (LocalData_i)) after the data augmentation process. The AI model generation unit 204 inputs the data DA_i (NNFE_i (LocalData_i)) to a k-layer neural network to generate a local AI model NN_i (DA_i (NNFE_i (LocalData_i))). Then, as in Embodiment 1, the AI model extraction unit 205 outputs an extracted AI model Ext (AI_model_weight_i) obtained by extracting information necessary for federated learning from the AI model generated by the AI model generation unit 204, and the transmitting and receiving unit 207 transmits the extracted AI model Ext (AI_model_weight_i) to the FL server 100. The FL server 100 performs federated learning using the data property characteristic information of the data for each FL client 200 and the extracted AI model Ext (AI_model_weight_i), which have been received from the FL client 200, to generate a common AI model and transmits, to each FL client 200, the generated common AI model and the adjusted augmentation method and intensity for the local data D which is the basis of the extracted AI model used for the common AI model.

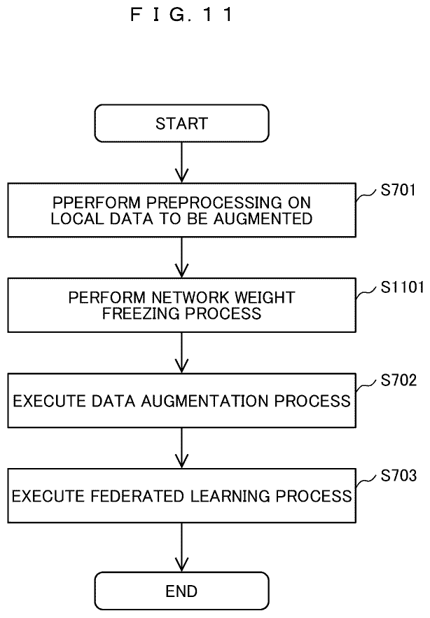

Next, the process performed in Embodiment 2 will be described. FIG. 11 is a flowchart showing a processing procedure of a data augmentation federated learning process performed in this embodiment. In FIG. 11, the same processes (S701, S702, and S703) as those in Embodiment 1 are performed except that, in S1101, the feature amount extraction process of freezing weights of a predetermined layer constituting the neural network and extracting a feature amount of image data is performed and the extracted feature amount is output as data in the latent representation vector format and input to the data augmentation process (S1101). Then, when the process in S703 is ended, the data augmentation process using the data in the latent representation vector format in consideration of overlearning is performed on the local data of the FL client 200 with the augmentation method and intensity of each FL client.

As described above, the federated learning system 2000 according to Embodiment 2 includes a plurality of client terminals (FL clients 200) and a server (FL server 100) that performs federated learning on data (local data D) to be processed by each of the plurality of client terminals. Each of the plurality of client terminals performs a feature amount extraction process (the process by the AI model feature amount extraction unit 901) of inputting the data to be processed to a neural network, in which a weight of a predetermined layer is fixed, to extract a feature amount of the data, performs an output process (the process by the AI model feature amount extraction unit 901) of outputting the extracted feature amount as data in a latent representation vector format, and inputs the data in the latent representation vector format to execute the data augmentation process. Therefore, the learning method is more easily performed with higher accuracy than the method described in Embodiment 1, and it is possible to suppress performance degradation of the common AI model.

### Embodiment 3

In Embodiment 2, the weights of a certain layer constituting the neural network are frozen and fixed in consideration of overlearning, which makes it possible to accurately suppress performance degradation of the common AI model through easy learning. However, depending on the application environment of this system, it may be desirable that weighting parameters of the neural network can be learned to generate a common AI model with higher accuracy and the adjusted augmentation method and intensity are reflected in the FL client 200. Therefore, in this embodiment, a case where weights of a predetermined layer constituting the neural network are learned will be described.

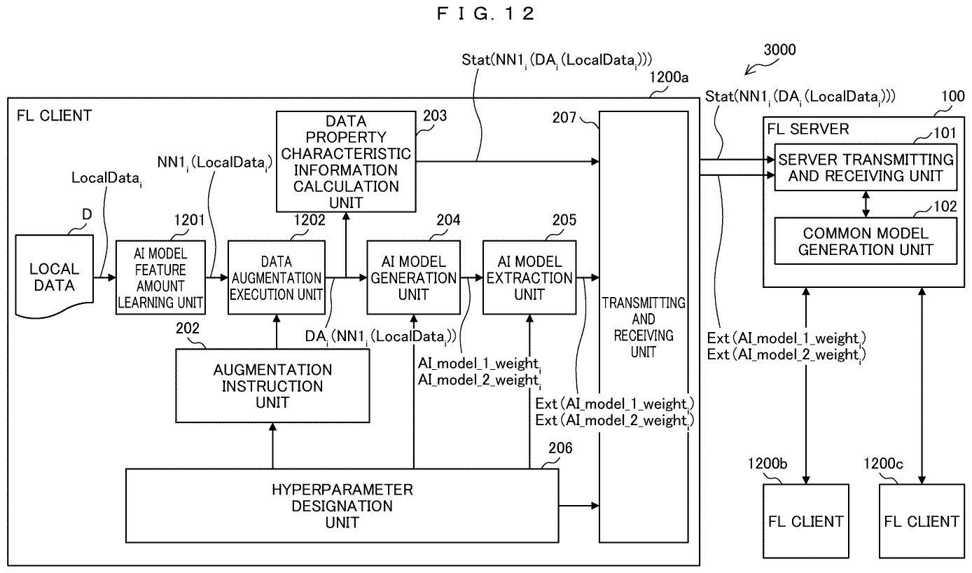

FIG. 12 is a diagram showing an example of a configuration of a federated learning system according to this embodiment. As shown in FIG. 12, a federated learning system 3000 includes an FL client that has the same configuration as the FL client 200 according to Embodiment 2 except that it includes an AI model feature amount learning unit 1201 instead of the AI model feature amount extraction unit 901. In addition, the FL client includes a data augmentation execution unit 1202 different from the data augmentation execution unit 201 according to Embodiment 2. In the following description, the same components as those in Embodiment 1 are denoted by the same reference numerals, and a description thereof will be omitted.

The AI model feature amount learning unit 1201 reads local data and outputs an image feature amount vector. In Embodiment 2, in the feature amount extraction process, the weights of the predetermined layer constituting the neural network are frozen, and the feature amount of the image data is extracted. However, in this embodiment, the weights of each layer including the predetermined layer are learned, a feature extraction process of extracting the feature amount of the image data after the learning is performed, and the extracted feature amount is output as an image feature amount vector in the latent representation vector format. Then, as in Embodiment 2, the AI model generation unit 204 generates a predetermined AI model from the augmented local data output by the data augmentation process.

In FIG. 12, the AI model feature amount learning unit 1201 reads “LocalData_i” as the local data D and outputs the image feature amount vector NN1_i (LocalData_i). The subscript i may be considered as in Embodiment 2.

In Embodiment 3, the AI model feature amount learning unit 1201 reads the augmentation method and intensity designated by the hyperparameter designation unit 206, the other parameters, and the weights of each layer constituting the neural network and outputs the image feature amount vector which is a latent representation vector after the feature amount of the local data D is extracted. When determining that the common AI model subjected to the federated learning by the FL server 100 does not provide performance equal to or higher than a predetermined level, the AI model feature amount learning unit 1201 learns the hyperparameters including the data augmentation method and intensity distributed to the FL client 200 such that the common AI model satisfies the predetermined level of performance, which will be described in detail below. The predetermined level of performance means, for example, a level satisfying the condition designated in each FL client 200 (for example, within the range of image roughness caused by scaling that is permitted at the location where a certain FL client 200 is installed).

In addition, the data augmentation execution unit 1202 performs the above-described data augmentation process in response to an instruction from the augmentation instruction unit 202 and outputs data DA_i (NN1_i (LocalData_i)) after the data augmentation process. For example, when the local data D is image data, the augmentation instruction unit 202 outputs the same parameters as those in Embodiment 2 to the data augmentation execution unit 1202.

The data property characteristic information calculation unit 203 reads the data DA_i (NN1_i (LocalData_i)) after the data augmentation process, calculates data property characteristic information of the data, and outputs the calculated data property characteristic information Stat (NN1_i (DA_i (LocalData_i))). For example, the data property characteristic information calculation unit 203 calculates, as the data property characteristic information of the data, the characteristic property of the image data, which is the local data D, based on statistical values, such as the average value and variance of the entire image or each channel of the image data, as in Embodiment 2. Alternatively, the data property characteristic information calculation unit 203 may use a data distribution calculated from the data feature amount converted by the trained encoder as the data property characteristic information of the data. Then, the transmitting and receiving unit 207 transmits the data property characteristic information of the data to the FL server 100, and the AI model generation unit 204 generates data-augmented local AI models AI_model_1_weight_i and AI_model_2_weight_i in the FL client 200 as in Embodiment 2.

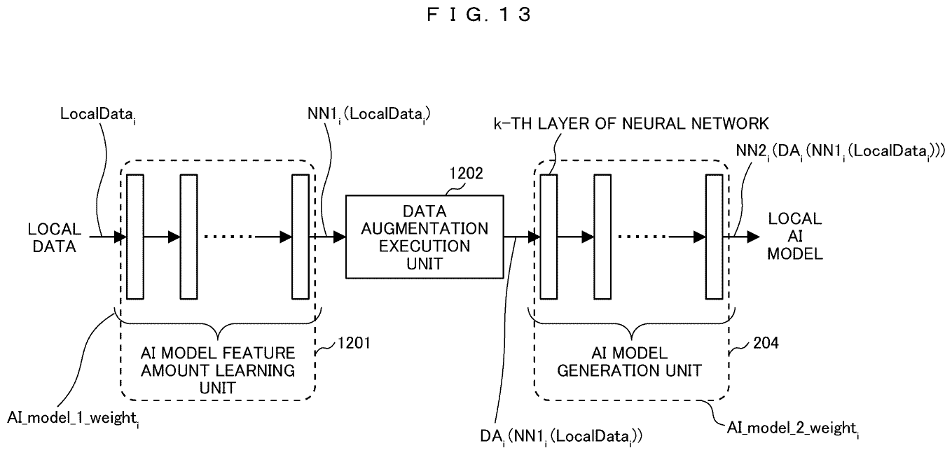

FIG. 13 is a diagram showing a procedure of generating an AI model from the local data D. As shown in FIG. 13, first, the AI model feature amount learning unit 1201 reads the local data D, performs the above-described feature amount extraction process, and outputs the image feature amount vector NN1_i (LocalData_i). When performing the feature amount extraction process, the AI model feature amount learning unit 1201 extracts a feature amount of the image data using a neural network AI_model_1_weight_i, in which the weights of a predetermined layer are not frozen, and outputs an image feature amount vector in the latent representation vector format.

Then, the data augmentation execution unit 1202 performs the data augmentation process on the image feature amount vector and outputs the data DA_i (NN1_i (LocalData_i)) after the data augmentation process. The AI model generation unit 204 inputs the data DA_i (NN1_i (LocalData_i)) to a k-layer neural network AI_model_2_weight_i to generate a local AI model NN2_i (DA_i(NN1_i(LocalData_i)).

Then, as in Embodiment 2, the AI model extraction unit 205 outputs extracted AI models Ext (AI_model_1_weight_i) and Ext (AI_model_2_weight_i) obtained by extracting information necessary for federated learning from the AI models generated by the AI model generation unit 204, and the transmitting and receiving unit 207 transmits the extracted AI models Ext (AI_model_1_weight_i) and Ext (AI_model_2_weight_i) to the FL server 100. The FL server 100 performs federated learning using the data property characteristic information of the data for each FL client 200 and the extracted AI models Ext (AI_model_1_weight_i) and Ext (AI_model_2_weight_i), which have been received from the FL client 200, to generate a common AI model and transmits, to each FL client 200, the generated common AI model and the adjusted augmentation method and intensity for the local data D which is the basis of the extracted AI models used for the common AI model.

Then, in the FL client 200, the AI model feature amount learning unit 1201 determines whether or not the common AI model subjected to the federated learning by the FL server 100 provides performance equal to or higher than a predetermined level. When determining that the common AI model does not provide the performance equal to or higher than the predetermined level, the AI model feature amount learning unit 1201 learns the hyperparameters including the data augmentation method and intensity distributed to the FL client 200 such that the common AI model satisfies the predetermined level of performance. Learning to satisfy the predetermined level of performance means, for example, learning the adjusted data augmentation method and intensity, the other parameters, and the weights of each layer constituting the neural network such that the condition designated in each FL client 200 is satisfied. An example of the condition is that the common AI model generated by the FL server 100 is within the range of image roughness caused by scaling that is permitted at the location where a certain FL client 200 is installed.

Then, the data augmentation execution unit 1202 executes the data augmentation process again, using the image feature amount vector NN1_i (LocalData_i) learned and output by the AI model feature amount learning unit 1201 as an input, and outputs the data DA_i (NN1_i (LocalData_i)) after the data augmentation process. Then, the same process as described above is repeated until it is determined that the adjusted augmentation method and intensity bring a certain level of performance to the common AI model.

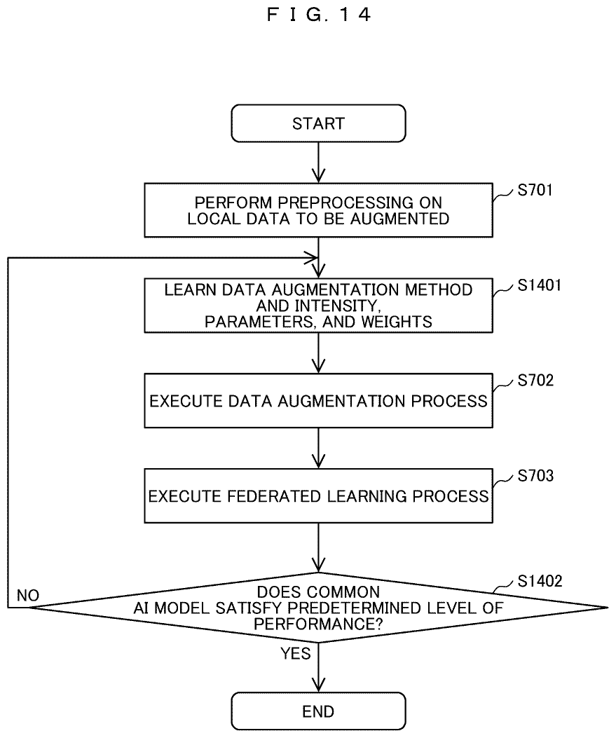

Next, the process performed in Embodiment 3 will be described. FIG. 14 is a flowchart showing a processing procedure of the data augmentation federated learning process performed in this embodiment. In FIG. 14, the same processes (S701, S702, and S703) as those in Embodiment 2 are performed except that, in S1401, the AI model feature amount learning unit 1201 learns the data augmentation method and intensity, the other parameters, and the weights of each layer constituting the neural network, performs the feature amount extraction process of extracting the feature amount of the image data, and performs a process of outputting the extracted feature amount as the data in the latent representation vector format to be input to the data augmentation process (S1401). In addition, in S1402, the AI model feature amount learning unit 1201 determines whether or not the common AI model subjected to the federated learning by the FL server 100 provides performance equal to or higher than a predetermined level (S1402).

When determining that the adjusted augmentation method and intensity do not bring the performance equal to or higher than the predetermined level to the common AI model (S1402; No), the AI model feature amount learning unit 1201 learns the hyperparameters including the data augmentation method and intensity distributed to the FL client 200 such that the common AI model satisfies the predetermined level of performance. On the other hand, when determining that the adjusted augmentation method and intensity bring the performance equal to or higher than the predetermined level to the common AI model (S1402; Yes), the AI model feature amount learning unit 1201 ends this process on the FL client 200.

Then, when the process in S1402 is ended, the data augmentation process using the feature amount obtained by learning the adjusted data augmentation method and intensity, the other parameters, and the weights of each layer constituting the neural network is performed on the local data of the FL client 200, with the method and intensity of each FL client.

As described above, the federated learning system 2000 according to the third embodiment includes a plurality of client terminals (FL clients 200) and a server (FL server 100) that performs federated learning on data (local data D) to be processed by each of the plurality of client terminals. The server performs a common model generation process of generating a common AI model, which is a model after the federated learning, with the federated learning using the learning model generated in each of the plurality of client terminals. In the feature amount extraction process, when the common AI model generated in the server does not satisfy a predetermined level of performance, each of the plurality of client terminals learns the predetermined data augmentation method and the intensity of the augmentation by the data augmentation method such that the common AI model satisfies the predetermined level of performance (performs the process by the AI model feature amount learning unit 1201). Therefore, this method can suppress the performance degradation of the common AI model with higher accuracy than the method described in Embodiment 2.

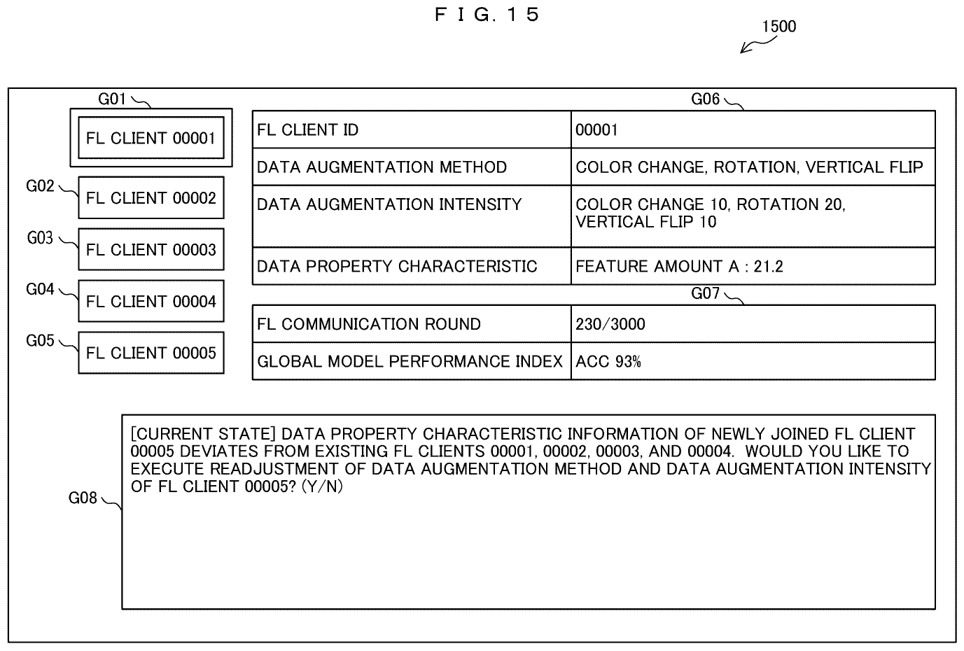

FIG. 15 is a diagram showing an example of an interface screen 1500 that is displayed on the display device 305 by the hyperparameter designation unit 206 of the FL client 200 according to each embodiment.

As shown in FIG. 15, the interface screen 1500 includes regions G01 to G05 indicating the FL clients 200 constituting this system, an input region G06 for inputting hyperparameters to be set for an FL client 200 selected from the FL clients 200 displayed in the regions G01 to G05, a condition input region G07 for inputting conditions for determining whether or not the adjusted augmentation method and intensity bring the performance equal to or higher than a predetermined level to the common AI model, and an input display region G08 for displaying processing results in each step of the data augmentation federated learning process, in which the FL server 100 determines that the distance between the data property characteristic information items is not smaller than the predetermined threshold value and readjusts the adjusted augmentation method and intensity, and for inputting an instruction for the display.

FIG. 15 shows an example of a screen when various types of information are input in the input region G06 for an FL client 200 with an identification ID “00001” among five FL clients 200 (00001 to 00005) constituting this system. FIG. 15 shows that, in the input region G06, in addition to the FL client ID “0001” indicating the identification ID, “color change, rotation, and vertical flip” is designated as the data augmentation method, and “10”, “20”, and “10” are designated as the data augmentation intensity in the “color change”, the “rotation”, and the “vertical flip”, respectively. In Embodiments 1 to 3, the hyperparameter designation unit 206 receives these types of information designated or input from the user. In addition, “feature amount A: 21.2” is displayed as the data property characteristic information in the input region G06. The data property characteristic information is information calculated from the augmented local data subjected to the data augmentation process by the data property characteristic information calculation unit 203 of the FL client 200.

Further, an “FL communication round” indicating an upper limit value of the number of exchanges between the FL client 200 and the FL server 100 via the network 300 and the actual number of exchanges is displayed in the condition input region G07. In this example, the current number of exchanges of “230” and the upper limit number of exchanges of “3000” are displayed. In Embodiment 3, the numbers of exchanges indicate, for example, the number of exchanges until it is determined that the adjusted augmentation method and intensity bring the performance equal to or higher than the predetermined level to the common AI model and the upper limit value of the number of exchanges.

Furthermore, in Embodiments 1 to 3, in the input display region G08, information indicating that it is determined that the distance between the data property characteristic information of the FL client 200 (identification ID “00005”) calculated in S803 and the data property characteristic information of the other FL clients 200 (identification IDs “00001” to “00004”) is not smaller than a predetermined threshold value, that is, that they deviate from each other is displayed, and the user is asked whether to readjust the data augmentation method and intensity. This inquiry may be displayed, for example, when S807 in FIG. 8 is executed.

When the user receives the inquiry and inputs, for example, “Yes”, the processes in S807 and S808 are executed, and the process in S702 is executed again. When the user inputs “No”, the process shown in FIG. 7 is ended.

As described above, each of the plurality of client terminals outputs an input and output screen (the interface screen 1500 in FIG. 15) having an input region (G06) for inputting the predetermined parameters and a display region (G08) for outputting a result of determining whether or not the predetermined relationship between the data property characteristic information items is satisfied and receives a new input of the predetermined parameters and an instruction to re-execute the adjustment process from the user through the input and output screen according to the determination result. Therefore, the user can easily understand the necessity for readjusting the data augmentation method and intensity and can issue an instruction to readjust the data augmentation method and intensity as necessary.

As described above, according to each embodiment, even when there is a high degree of heterogeneity in the statistical properties of the local learning data held by each location, it is possible to reduce the performance degradation of the common AI model obtained by federated learning. In the federated learning, the use of the technologies disclosed in Non-Patent Documents 1 and 2 makes it possible to build a common AI model between a large number of business offices/operators with different data collection environments (an angle of view, resolution, a focus, illuminance, and the like), while suppressing performance degradation and avoiding an increase in SI costs due to individual optimization (learning) of AI. However, as already described above, when there is a large difference between the data collection environments at each location, it is still difficult to suppress the performance degradation of the common model using only these techniques. In contrast, in each of the above-described embodiments, the individual data augmentation processes adjusted for each location are applied to modify the statistical properties of the local data held by each location, and the characteristics of the local data for each location are aligned. Therefore, even when there is a high degree of heterogeneity in the distribution of raw data between the locations, it is possible to perform federated learning while maintaining the performance of the common AI model.

The present invention is not limited to the above-described embodiments. In an implementation phase, the components can be modified and embodied without departing from the gist of the present invention, or a plurality of components disclosed in the above-described embodiments can be appropriately combined.

### REFERENCE SIGNS LIST

1000, 2000, 3000 Federated learning system
100 FL server
200, 900, 1200 FL client
300 Network
204 AI model generation unit
102 Common model generation unit
101 Server transmitting and receiving unit
201 Data augmentation execution unit
202 Augmentation instruction unit
203 Data property characteristic information calculation unit
204 AI model generation unit
205 AI model extraction unit
206 Hyperparameter designation unit
207 Transmitting and receiving unit
901 AI model feature amount extraction unit
902 Data augmentation execution unit
1201 AI model feature amount learning unit
1202 Data augmentation execution unit

1. A federated learning system comprising:
a plurality of client terminals; and
server performing federated learning on data to be processed by each of the plurality of client terminals,
wherein each of the plurality of client terminals executes a data augmentation process of augmenting the data to be processed based on a predetermined data augmentation method and an intensity of augmentation by the data augmentation method, executes a learning model generation process of generating a predetermined learning model from the data augmented by the data augmentation process according to a predetermined parameter, and executes a calculation process of calculating data property characteristic information indicating a characteristic property of the data from the augmented data,
when the data property characteristic information of one of the client terminals does not satisfy a predetermined relationship with the data property characteristic information of another client terminal, the server executes an adjustment process of adjusting the predetermined data augmentation method and the intensity of the augmentation by the data augmentation method for the one client terminal, using the predetermined learning model generated from the augmented data, such that the data property characteristic information items of the two client terminals satisfy the predetermined relationship, and the one client terminal executes the data augmentation process, the learning model generation process, and the calculation process based on the adjusted predetermined data augmentation method and the adjusted intensity of the augmentation by the data augmentation method.

2. The federated learning system according to claim 1,
wherein each of the plurality of client terminals performs a feature amount extraction process of inputting the data to be processed to a neural network, in which a weight of a predetermined layer is fixed, to extract a feature amount of the data, performs an output process of outputting the extracted feature amount as data in a latent representation vector format, and inputs the data in the latent representation vector format to execute the data augmentation process.

3. The federated learning system according to claim 2,
wherein the server performs a common model generation process of generating a common AI model, which is a model after the federated learning, with federated learning using the learning model generated in each of the plurality of client terminals, and
in the feature amount extraction process, when the common AI model generated in the server does not satisfy a predetermined level of performance, each of the plurality of client terminals learns the predetermined data augmentation method and the intensity of the augmentation by the data augmentation method such that the common AI model satisfies the predetermined level of performance.

4. The federated learning system according to claim 1, wherein each of the plurality of client terminals outputs an input and output screen having an input region for inputting the predetermined parameter and a display region for outputting a result of determining whether or not the predetermined relationship between the data property characteristic information items is satisfied and receives a new input of the predetermined parameter and an instruction to re-execute the adjustment process from a user through the input and output screen according to the determination result.

5. A federated learning method performed by a federated learning system including a plurality of client terminals and a server performing federated learning on data to be processed by each of the plurality of client terminals, the federated learning method comprising:
causing each of the plurality of client terminals to execute a data augmentation process of augmenting the data to be processed based on a predetermined data augmentation method and an intensity of augmentation by the data augmentation method, to execute a learning model generation process of generating a predetermined learning model from the data augmented by the data augmentation process according to a predetermined parameter, and to execute a calculation process of calculating data property characteristic information indicating a characteristic property of the data from the augmented data;
causing the server to, when the data property characteristic information of one of the client terminals does not satisfy a predetermined relationship with the data property characteristic information of another client terminal, execute an adjustment process of adjusting the predetermined data augmentation method and the intensity of the augmentation by the data augmentation method for the one client terminal, using the predetermined learning model generated from the augmented data, such that the data property characteristic information items of the two client terminals satisfy the predetermined relationship; and
causing the one client terminal to execute the data augmentation process, the learning model generation process, and the calculation process based on the adjusted predetermined data augmentation method and the adjusted intensity of the augmentation by the data augmentation method.

6. The federated learning method according to claim 5,
wherein each of the plurality of client terminals performs a feature amount extraction process of inputting the data to be processed to a neural network, in which a weight of a predetermined layer is fixed, to extract a feature amount of the data, performs an output process of outputting the extracted feature amount as data in a latent representation vector format, and inputs the data in the latent representation vector format to execute the data augmentation process.

7. The federated learning method according to claim 6,
wherein the server performs a common model generation process of generating a common AI model, which is a model after the federated learning, with federated learning using the learning model generated in each of the plurality of client terminals, and
in the feature amount extraction process, when the common AI model generated in the server does not satisfy a predetermined level of performance, each of the plurality of client terminals learns the predetermined data augmentation method and the intensity of the augmentation by the data augmentation method such that the common AI model satisfies the predetermined level of performance.

8. The federated learning method according to claim 5,
wherein each of the plurality of client terminals outputs an input and output screen having an input region for inputting the predetermined parameter and a display region for outputting a result of determining whether or not the predetermined relationship between the data property characteristic information items is satisfied and receives a new input of the predetermined parameter and an instruction to re-execute the adjustment process from a user through the input and output screen according to the determination result.
